(19) United States
(12) Patent Application Publication
(10) Pub. No.: US 2013/0011623 A1
(43) Pub. Date: Jan. 10, 2013

(54) MONOLITHIC THREE-DIMENSIONAL COMPOSITE AND METHOD OF MAKING SAME

(75) Inventors: David Michael Jones, Dacula, GA (US); Randy Eugene Johnson, Lula, GA (US); Kevin Nelson King, Alto, GA (US); Wallace L. Hanson, JR., Duluth, GA (US); Guy J. Stokes, Newnan, GA (US); John B. McIntyre, Peachtree Corners, GA (US); Charles Demarest, Boulder, CO (US)

(73) Assignees: Nicolon Corporation d/b/a Tencate Geosynthetics North America, Pendergrass, GA (US); THE HANSON GROUP, LLC, Alpharetta, GA (US)

(21) Appl. No.: 13/542,923

(22) Filed: Jul. 6, 2012

Related U.S. Application Data
(60) Provisional application No. 61/505,605, filed on Jul. 8, 2011.

(51) Int. Cl. E04C 2/22; B32B 5/28; B32B 27/12; B32B 5/02; B32B 3/10; B29C 39/10; B32B 3/30

(52) U.S. Cl. 428/160; 264/279.1; 442/205; 428/172; 428/196; 442/189; 442/192

(57) ABSTRACT

Described herein is a monolithic three-dimensional composite having a three-dimensional layer impregnated with an outer layer of polyurea, polyurethane, or a blend thereof. In one aspect the three-dimensional layer is woven fabric of a plain 4-layer tubular weave. Optionally, the outer layer has a three-dimensional relief to simulate three-dimensional structures.

### CROSS-REFERENCE TO RELATED APPLICATION

This application claims a benefit of priority from U.S. Provisional Patent Application Ser. No. 61/505,605 filed Jul. 8, 2011, which is incorporated herein in its entirety by reference.

### TECHNICAL FIELD OF THE INVENTION

The present invention relates generally to composite panels and flooring structures. More specifically, the present invention is related to a monolithic, three-dimensional composite structure of a polyurethane and/or a polyurea layer disposed on a three-dimensional woven fabric employable as a wall panel, a flooring component, or other component of a structure or device.

### BACKGROUND OF THE INVENTION

Certain composite components are utilized in the construction industry to fabricate buildings or other dwelling structures. Examples of such composites include gypsum board and fiber-reinforced cementitious board, also referred to as cultured stone. However, gypsum board and like products typically are utilized in water-free environments. Moreover, gypsum board is heavy and has limited flexibility, durability, impact resistance, and load bearing capability. Although cultured stone and the like can be utilized in wet environments, such products likewise are heavy and have limited flexibility, durability, impact resistance, and load bearing capability. Also, it is difficult to form three-dimensional reliefs on these products which simulate other products, such as stone, brick, wood, tile and patterns thereof, mosaics, etc., whether used as a wall or a floor component.

Fabricated flooring products, such as engineered hardwood, polymer-based tile, laminate sheeting, Formica, and the like have seams or joints between adjacent units when installed. Unless the flooring space is smaller than the pre-fabricated sheet being installed, two or more sheets must be employed. As a result, the floor has seams where the adjacent sheets abut one another. Moreover, none of the pre-fabricated flooring products are fabricated on-site to form a seamless floor of any sized area.

Thus, there is a need for a monolithic three-dimensional composite which has a three-dimensional relief. Additionally, there is a need for a monolithic three-dimensional composite which is seamless regardless of the configuration and/or coverage size of the installation coverage area. Moreover, there is a need for a monolithic three-dimensional composite to be light-weight, flexible, durable, and load bearing. It is to meeting these needs that the monolithic three-dimensional composite described herein is directed.

### SUMMARY OF THE INVENTION

In accordance with the present invention, a monolithic three-dimensional composite and method of making such composite is described herein. The composite comprises a three-dimensional layer comprising a single-weave, three-dimensional fabric and an outer layer disposed within a portion of and extending outwardly from the three-dimensional fabric. The outer layer comprises a polyurea, a polyurethane, or a blend thereof. Alternatively, the outer layer comprises a foam of a polyurea, polyurethane, or a blend thereof. In one aspect, the three-dimensional fabric comprises a plain 4-layer tubular weave, but is not limited to such a weave. In another aspect, outer layer of the monolithic three-dimensional composite comprises a three-dimensional relief. The three-dimensional relief is a replication of any desired pattern. Still, in another aspect, the outer layer of the monolithic three-dimensional composite comprises a print layer and a three-dimensional relief in register with the print layer. Yet, in another aspect, the outer layer of the monolithic three-dimensional composite comprises a print layer and is embossed-in-register with the print layer to form a three-dimensional relief.

The print design of the print layer can be any print pattern or design. Such designs include, but are not limited to, those resembling natural floor surfaces, natural wall surfaces, and the like. For instance, the print design can resemble natural wood or planks of natural wood. The design pattern can simulate ceramic surfaces, brick, stone, and the like. The print design can simulate the design/pattern of natural wood, stone, marble, granite, ceramic, or brick appearance, and the design can include one or more joint or grout lines or borders. The print design can be any artistic design/pattern simulating a natural surface or a man-made surface or other non-natural design such as found in tiles, resilient flooring, and the like.

It is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the present invention. It is important, therefore, that the claims be regarded as including such equivalent constructions insofar as they do not depart from the spirit and scope of the present invention.

Other advantages and capabilities of the invention will become apparent from the following description taken in conjunction with the accompanying drawings showing the embodiments and aspects of the present invention.

### BRIEF DESCRIPTION OF THE OF DRAWINGS

The disclosure below makes reference to the annexed drawings wherein:

FIG. 1 is a side view of a monolithic three-dimensional composite in accordance with the present invention illustrating an outer layer and a three-dimensional layer.

FIG. 2 is a partial side view of the monolithic three-dimensional composite illustrating the outer layer permeating and encapsulating yarns of the three-dimensional layer.

FIG. 3 is a perspective side view of the monolithic three-dimensional composite illustrating the outer layer having a three-dimensional relief.

FIG. 4 is an elevation view of the monolithic three-dimensional composite of FIG. 3.

FIG. 5 is a side section view of the monolithic three-dimensional composite taken along line A-A.

FIG. 6 is a perspective view of a mold receiving polymer in accordance with the method of making the three-dimensional composite having a three-dimensional relief.

FIG. 7 is a perspective view of the mold of FIG. 6 receiving the three-dimensional layer.

FIG. 8 is a top view of an exemplary printed pattern on the three-dimensional composite.

FIG. 9 is a side view of the three-dimensional composite having a three-dimensional relief embossed in register with a print layer.

FIG. 10 is an illustration of a process for, optionally, applying a wear layer to the three-dimensional composite and subsequently mechanically embossing the composite.

### DETAILED DESCRIPTION

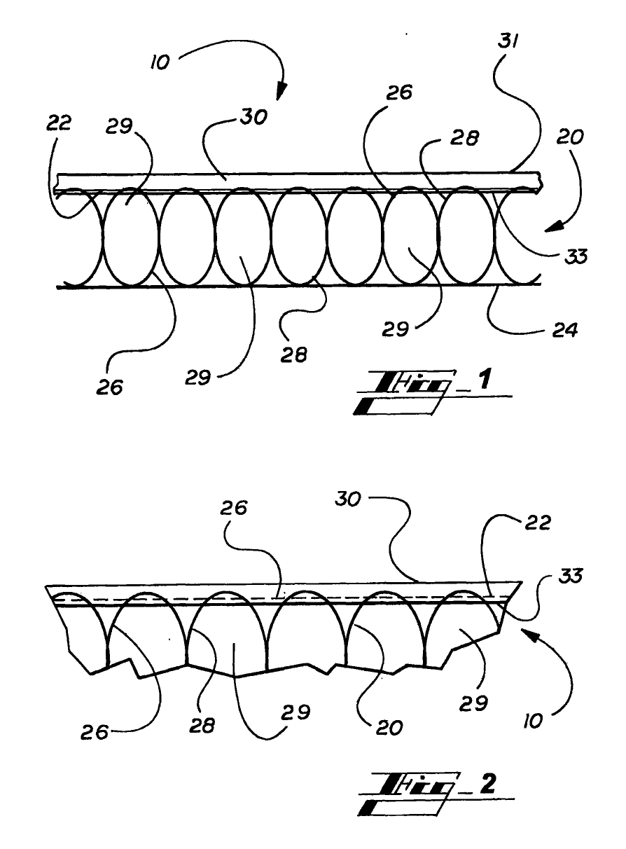

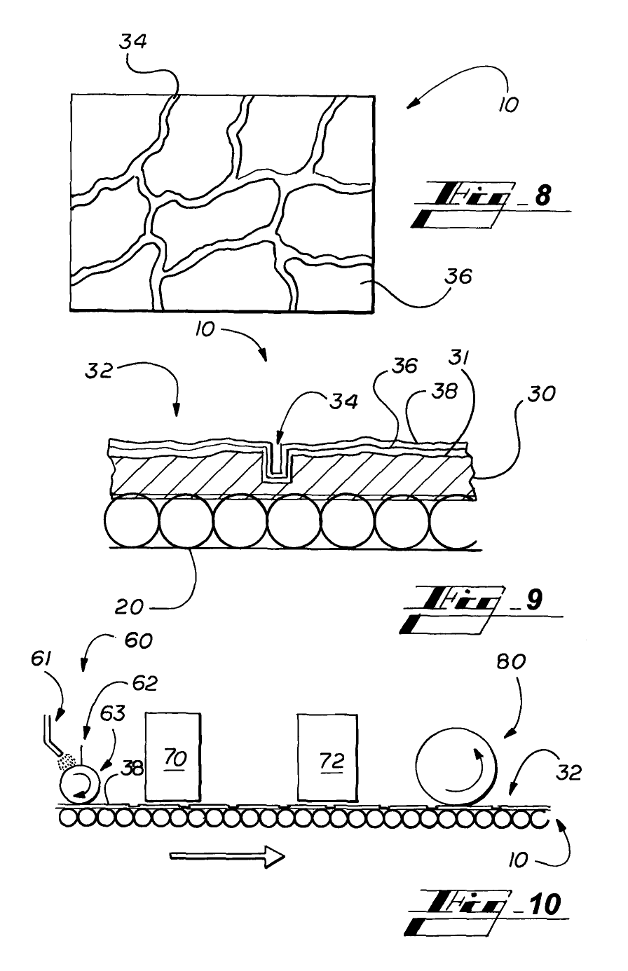

Referring to FIGS. 1 and 2, a monolithic three-dimensional composite 10 in accordance with the present invention is shown. The composite 10 comprises a three-dimensional layer 20 comprising a single-weave, three-dimensional fabric and an outer layer 30 disposed within a portion of and extending outwardly from the three-dimensional layer 20. Outer layer 30 has an outer surface 31 and an inner surface 33. As illustrated in FIG. 8, a print layer 36, such as the illustrated stone and grout motif, can be disposed on the outer surface 31 of the outer layer 30 by any conventional means. The print layer 36 can be presented in any desired pattern, such as a decorative pattern, e.g. stone, brick, ceramic tile, wood grain and knots, an inlay, grout lines, etc. In one aspect, outer layer 30 comprises a polyurea, a polyurethane, or a combination thereof. In another aspect, the outer layer 30 comprises a foam of a polyurea, a polyurethane, or a combination thereof. Optionally, a wear layer 38 can be disposed on the print layer 36. The wear layer 38 can be composed of any suitable material known in the art for this purpose. For example, the wear layer 38 can comprise a urethane.

As illustrated in FIGS. 1 and 2, the fabric of the three-dimensional layer 20 comprises a plain 4-layer tubular weave. However, the three-dimensional layer 20 is not limited to a 4-layer tubular weave. Any fabric comprising a three-dimensional structure, either woven or non-woven, can be employed as the three-dimensional layer 20 as long as the outer layer 30 encapsulates at least a portion of the yarns comprising the three-dimensional layer 20. A fabric comprising a three-dimensional structure has at least one system of yarns in which the yarns are disposed in the x-, y-, and z-axes of space originating from a plane and provides mechanical stability along all three such axes. While the three-dimensional fabric can have at least one face that is planar or substantially planar, it is not limited to such fabrics. Three-dimensional fabrics having substantially no planar face, for example, the fabric described in U.S. Patent Application Publication No. 2010/0248574 to King et al., which is incorporated herein in its entirety by reference, can be employed as the three-dimensional layer 20.

In another aspect, outer layer 30 of the monolithic three-dimensional composite 10 comprises a three-dimensional relief 32. The three-dimensional relief 32 is a replication of any desired pattern, for example, brick, stone, wood, tile, etc. The three-dimensional relief 32 can be molded into the outer layer 30 as it is being disposed onto the three-dimensional layer 20 and/or mechanically embossed into the outer surface 31 of the outer layer 30.

As known in the art, a woven fabric has two principle directions, one being the warp direction and the other being the weft direction. The warp direction is the length-wise or machine direction of the fabric. The weft direction, also known as the fill direction, is the direction across the fabric, from edge to edge, or the direction traversing the width of the weaving machine. The words “weft” and “fill” are utilized herein interchangeably. Thus, the warp and fill directions are generally perpendicular to each other. The set of yarns, tapes, threads, or monofilaments running in each direction are referred to as the warp yarns and the fill yarns (or weft yarns), respectively.

A woven fabric can be produced with varying densities. This is usually specified in terms of number of the ends per inch in each direction, warp and fill. The higher this value is, the more ends there are per inch and, thus, the fabric density is greater or higher.

The weave pattern of fabric construction is the pattern in which the warp yarns are interlaced with the fill yarns. A woven fabric is characterized by an interlacing of these yarns.

The three-dimensional layer 20, provides support for the outer layer 30 and impact dampening and energy dissipation for the monolithic composite 10. In one aspect, the three-dimensional layer 20 comprises a three-dimensional, plain 4-layer tubular weave with multiple yarns in both diameter warp and fill and varying degrees of shrinker force. In another aspect, the three-dimensional layer 20 comprises a combination of polypropylene and polyethylene yarns.

Three-dimensional layer 20, as illustrated in the figures, is single weave fabric of unitary construction comprising four layers. In the art, a layer is sometimes referred to as a “ply”. Fabric 20 has a first layer 22 spaced apart from a second layer 24 with a third layer 26 and a fourth layer 28 disposed between first and second layers 22 and 24. As illustrated in FIG. 1, third and fourth layers 26 and 28 in combination define tubes 29 which provide energy dampening and dissipation capability for the composite 10. The tubular shape can be generally circular or oval in cross-section. Moreover, the three-dimensional layer 20 provides dimensional stability, strength, and load bearing capacity to the composite 10 while only having the weight of a four-layer woven fabric. Because the respective tubes 29 are hollow and permeable, air flow through the three-dimensional layer 20 is maintained. Since the tubes 29 are formed of successive yarns along the length thereof, the tubes 29 are permeable between the respective yarns. Thus, air-flow can occur in either the warp or fill directions.

The three-dimensional layer 20 encompasses a three-dimensional woven structure designed to provide a means to dissipate energy due to its compressive resistance. The three-dimensional layer 20 reduces wave energy due to its internal structure provided by the woven three-dimensional fabric, for example, woven cylinders and a tortuous path to penetrate the material. The outer layer 30 provides a solid supporting surface which adds strength and stability to the three-dimensional composite 10.

As illustrated, the woven three-dimensional layer 20 is a single weave fabric comprising shrink and non-shrink yarns. A shrink yarn is a yarn or monofilament which has a pre-determined differential heat shrinkage characteristic that is greater than a yarn or monofilament employed as a non-shrink yarn. Methods of making the illustrated three-dimensional layer 20 are described in U.S. Patent Application Publication No. US 2009/0197021 to Jones et al. and United Kingdom Patent No. 853,697 (also referenced as GB 853,697) published Nov. 9, 1960 and issued to United States Rubber Company. The three-dimensional layer 20 comprises:
first and second layers 22 and 24 comprising shrink yarns in the warp direction;
third and fourth layers 26 and 28 comprising non-shrink yarns in the warp direction; wherein
the third and fourth layers 26 and 28 are sandwiched between the first and second layers 22 and 24, wherein
the third and fourth layers 26 and 28 zigzag between first and second layers 22 and 24 and are alternatingly connected to the first and second layers 22 and 24, and wherein
the third and fourth zigzagging layers 26 and 28 are shifted relatively to each other over half a phase and are intertwined with each other.

For example, the three-dimensional layer 20 can be made from at least two types of yarn with different shrink characteristics. One type of yarn can have a relatively high shrink characteristic, such as polyethylene yarns while the other type of yarn can have a relatively low or no shrink characteristic, such as a polypropylene or polyester yarn. In addition, the shrink and non-shrink yarns can be of the same type of polymer, but of differing class with respect to shrinkage. For example, both the shrink and non-shrink yarns can be polyethylene, but one class of the polyethylene has a different shrink characteristic than the other class of polyethylene. The yarns can be woven or otherwise fixed together to from an essentially flat structure. Thereafter, the flat woven structure is heated to shrink the shrink yarn and cause some or all of the yarns to increase in density and form a tubular-shaped fabric.

By heating the shrink yarns, the length of the first and second layers 22 and 24 respectively decrease. The length of the third and fourth layers 26 and 28 remain relatively constant, as these layers are made of non-shrink yarns. As a result the extra length has to be compensated. As the third and fourth layers 26 and 28 are already zigzagging, the non-shrink yarns curve and as the first and second zigzagging layers 22 and 24 are shifted over half a phase, tubular structures 29 are formed. These tubular structures 29 are inherently strong as a result of the shape and can provide shock absorbency and dimensional stability. Also the tubular structure 29 provides channels within the fabric, thereby providing air flow capability and drainage.

Typically, yarns employed in the three-dimensional layer 20 have a size between about 500 denier to about 5,000 denier. Non-shrink yarns employed in the three-dimensional layer 20 can have a size in a range between about 8 mils to about 30 mils. Shrink yarns typically have a size in a range between about 150 denier to about 1,800 denier. For example, a 20 mil, round polypropylene yarn can be employed as non-shrink yarn, and 315 denier, round low density polyethylene monofilament can be employed as the shrink yarn. In one aspect polypropylene yarn has a size between about 8 mils to about 30 mils. Low density polyethylene yarn has a size between about 200 denier to about 1,800 denier. The sizes of the yarns employed in the three-dimensional layer can comprise sizes different from those mentioned above. Thus, the sized mentioned should not be considered as limiting.

The three-dimensional layer 20 typically comprises a thickness of about 500 mils. In another aspect the three-dimensional layer 20 has a thickness between about 200 mils to about 1,000 mils. Still, in another aspect the thickness of the three-dimensional layer 20 is between about 150 mils to about 1,200 mils. Yet, in another aspect the thickness of the three-dimensional layer 20 is between about 250 to about 1,000 mils. Further, in another aspect the thickness of the three-dimensional layer 20 is between about 400 mils and about 750 mils. Yet still, in another aspect the thickness of the three-dimensional layer 20 is about 150 mils, about 200 mils, about 250 mils, about 300 mils, about 350 mils, about 400 mils, about 500 mils, about 550 mils, about 600 mils, about 650 mils, about 700 mils, about 750 mils, about 800 mils, about 850 mils, about 900 mils, about 950 mils, about 1,000 mils, about 1,050 mils, about 1,100 mils, about 1,150 mils, about 1,200 mils, or any range therebetween. Thickness is determined in accordance with ASTM International (ASTM) Standard D5199-01 (2006) entitled “Standard Test Method for Measuring the Nominal Thickness of Geosynthetics”.

Typically, the density or weight of the three-dimensional layer 20 is about 18 ounces/yard² (“osy”). In another aspect the weight of the three-dimensional layer 20 is between about 15 osy to about 22 osy. Still in another aspect the weight of the three-dimensional layer 20 is about 16 osy±5 osy. Yet, in another aspect the weight of the three-dimensional layer 20 is about 15 osy, about 15.5 osy, about 16 osy, about 16.5 osy, about 17 osy, about 17.5 osy, about 18 osy, about 18.5 osy, about 19 osy, about 19.5 osy, about 20 osy, about 20.5 osy, about 21 osy, about 21.5 osy, about 22 osy, about 22.5 osy, about 23 osy, about 23.5 osy, about 24 osy, about 24.5 osy, about 25 osy, or any range therebetween. Weight is determined in accordance with ASTM Standard D5261-10 entitled “Standard Test Method for Measuring Mass per Unit Area of Geotextiles”.

As mentioned above, the three-dimensional layer 20 comprising the three-dimensional composite 10 provides shock absorbency. Shock absorbency is expressed herein as a function of the compressibility of the fabric when subjected to a given load. Compressibility is determined in accordance with ASTM Standard D3575-08 entitled “Standard Test Methods for Flexible Cellular Materials Made from Olefin Polymers”. The three-dimensional layer 20 employed in the three-dimensional composite 10 has 10% compression at a load of about 32 pounds/inch² (“psi”). In another aspect the three-dimensional layer 20 has 25% compression at a load of about 38 psi. Yet, in another aspect the three-dimensional layer 20 has 50% compression at a load of about 45 psi. Still, in another aspect the three-dimensional layer 20 has 10% compression at a load of about 10 psi. Yet still, in another aspect the three-dimensional layer 20 has 10% compression at a load of about 20 psi. Still further, in another aspect the three-dimensional layer 20 has 10% compression at a load of about 20 psi, about 25 psi, about 26 psi, about 27 psi, about 28 psi, about 29 psi, about 30 psi, about 31 psi, about 32 psi, about 33 psi, about 34 psi, about 35 psi, or any range therebetween. Still yet further, in another aspect the three-dimensional layer 20 has 50% compression at a load of about 50 psi, about 60 psi, about 70 psi, about 80 psi, about 90 psi, about 100 psi, about 110 psi, about 120 psi, about 130 psi, about 140 psi, about 150 psi, or any range therebetween.

Typically, the three-dimensional layer 20 has a grab tensile of about 800 pounds warp and about 800 pounds fill as determined in accordance with ASTM Standard D4632-08 entitled “Standard Test Method for Grab Breaking Load and Elongation of Geotextiles”. In another aspect the grab tensile warp is about 700 pounds, about 750 pounds, about 800 pounds, about 850 pounds, or any range therebetween. Still, in another aspect the grab tensile fill is about 700 pounds, about 750 pounds, about 800 pounds, about 850 pounds, or any range therebetween.

The fibers or monofilaments comprising the aforementioned yarns are typically thermoplastic polymers. Additionally, yarns comprising natural fibers can be employed in the present invention. Polymers which may be used to produce the three-dimensional layer 20 include, but are not limited to, polyamides (for example, any of the nylons), polyimides, polyesters (for example, high tenacity polyesters, polyethylene terephthalate, such as mono polyethylene terephthalate, polybutylene terephthalate, and aromatic polyesters, for example, Vectran®), polyacrylonitriles, polyphenylene oxides, fluoropolymers, acrylics, polyolefins (for example, low density polyethylene (LDPE), linear low density polyethylene (LLDPE), high density polyetheylene (HDPE), co-polymers of polyethylene, polypropylene, and higher polyolefins), polyphenylene sulfide, polyetherimide, polyetheretherketone, polylactic acid (also known as polylactide), aramids (for example, para-aramids, which include Kevlar®, Technora®, Twaron®, and meta-paramids, for example, Nomex®, and Teijinconex®), aromatic ether ketones, vinalon, and the like, and blends of such polymers which can be formed into microfilaments. The yarns can comprise any shape, such as round, oval, rectangular, square, etc. Further, the yarns can comprise other agents, materials, dyes, plasticizers, etc. which are employed in the textile industry. In one aspect the yarns comprise an ultraviolet radiation resistant additive. It will be understood that any materials capable of producing fibers or microfilaments suitable for use in the instant fabric of the present invention fall within the scope of the present invention and can be determined without departing from the spirit thereof.

Furthermore, the respective yarns employed in the three-dimensional layer 20 can comprise at least one additive commonly used in conjunction with the material of the fiber. Such additives include, but are not limited to, plasticizers, processing aids, scavengers, heat stabilizers, antistatic agents, slip agents, dyes, pigments, antioxidants, ultraviolet light (radiation) stabilizers, metal deactivators, antistatic agents, flame retardants, lubricants, biostabilizers, and biocides.

The antioxidants, light stabilizers, and metal deactivators employed, if appropriate or desired, can have a high migration fastness and temperature resistance. Suitable antioxidants, light stabilizers, and metal deactivators include, but are not limited to, 4,4-diarylbutadienes, cinnamic esters, benzotriazoles, hydroxybenzophenones, diphenylcyanoacrylates, oxamides (oxalamides), 2-phenyl-1,3,5-triazines; antioxidants, nickel compounds, sterically hindered amines, metal deactivators, phosphites and phosphonites, hydroxylamines, nitrones, amine oxides, benzofuranones and indolinones, thiosynergists, peroxide scavengers, and basic costabilizers.

Examples of suitable antistatic agents include, but are not limited to, amine derivatives such as N,N-bis(hydroxyalkyl)alkylamines or -alkylenamines, polyethylene glycol esters and ethers, ethoxylated carboxylic esters and carboxamides, and glycerol monostearates and distearates, and also mixtures thereof.

The additives are used in typical amounts as provided in the respective product literature. For example, the respective additives, when present, are in an amount from about 0.0001% to 10% by weight based upon the total weight of the fiber. In another aspect, the respective additives are present in an amount from about 0.01% to about 1% by weight based on the total weight of the respective fiber.

The outer layer 30 comprises a composition which is a polyurea, a polyurethane, or a blend of polyurea and polyurethane. Polyurea is formed by reacting an isocyanate with an amine. The ratio of equivalents of isocyanate groups to equivalents of amine groups is greater than 1, for example 1.15, and the isocyanate and the amine reaction product can be applied to the three-dimensional layer 20 at a volume mixing ratio of 1:1. Polyurethane is formed by reacting an isocyante with a polyol.

In another aspect, the composition of the outer layer 30 can include flame and/or heat resistant material to improve the flame and/or heat resistance of the composite 10. As used herein, the terms “improved flame resistance” and “improved heat resistance” means any degree of improved flame resistance or heat resistance, respectively, that is demonstrated by a composition comprising polyurea, polyurethane, or combination thereof and flame and/or heat resistant material as compared to a like composition absent flame and/or heat resistant material.

As used herein, the term “isocyanate” includes unblocked compounds capable of forming a covalent bond with a reactive group such as a hydroxyl or amine functional group. In an alternate non-limiting aspect, the isocyanate can be monomeric containing one isocyanate functional group (NCO) or the isocyanate of the present invention can be polymeric containing two or more isocyanate functional groups (NCOs). Yet, in another aspect, the isocyanate includes diisocyanates having the generic structure O═C═N—R—N═C═O, where R is a cyclic, aromatic, or linear or branched hydrocarbon moiety containing from about 1 to about 50 carbon atoms.

Still, in another non-limiting aspect, the isocyanate is represented by the general formula, R—(N═C═O)ₓ, where R can be any organic radical having a valence x. R can be a straight or branched hydrocarbon moiety, acyclic group, cyclic group, heterocyclic group, aromatic group, phenyl group, hydrocarbylene group, or a mixture thereof. For example, R can be a hydrocarbylene group having about 6 to about 25 carbons. In another aspect, R is unsubstituted or substituted. For example, the cyclic or aromatic group(s) can be substituted at the 2-, 3-, and/or 4-positions, or at the ortho-, meta-, and/or para-positions, respectively. Substituted groups include, but are not limited to, halogens, primary, secondary, or tertiary hydrocarbon groups, or a mixture thereof.

Isocyanates for use in the present invention are numerous and can vary widely. Such isocyanates can include those that are known in the art. Examples of suitable isocyanates include, but are not limited to, monomeric and/or polymeric isocyanates. The polyisocyanates include monomers, prepolymers, oligomers, or blends thereof. In one aspect, the polyisocyanate can be C₂-C₂₀ linear, branched, cyclic, aromatic, or any blend thereof.

Isocyanates which can be employed in the present invention include, but are not limited to, 3,3,5-trimethyl-5-isocyanato-methyl-cyclohexyl isocyanate, also referred to as isophorone diisocyanate (IPDI); hydrogenated materials such as cyclohexylene diisocyanate, 4,4′-methylenedicyclohexyl diisocyanate (H₁₂MDI); mixed aralkyl diisocyanates such as tetramethylxylyl diisocyanates, OCN—C(CH₃)₂—C₆H₄C(CH₃)₂—NCO; polymethylene isocyanates such as 1,4-tetramethylene diisocyanate, 1,5-pentamethylene diisocyanate, 1,6-hexamethylene diisocyanate (HMDI), 1,7-heptamethylene diisocyanate, 2,2,4- and 2,4,4-trimethylhexamethylene diisocyanate, 1,10-decamethylene diisocyanate and 2-methyl-1,5-pentamethylene diisocyanate; and any mixture thereof.

Additional isocyanates which can be employed in the present invention include, but are not limited to, substituted and isomeric mixtures including 2,2′-, 2,4′-, and 4,4′-diphenylmethane diisocyanate (MDI); 3,3′-dimethyl-4,4′-biphenylene diisocyanate (TODI); toluene diisocyanate (TDI); polymeric MDI; carbodiimide-modified liquid 4,4′-diphenylmethane diisocyanate; para-phenylene diisocyanate (PPDI); meta-phenylene diisocyanate (MPDI); triphenyl methane-4,4′- and triphenyl methane-4,4″-triisocyanate; naphthylene-1,5-diisocyanate; 2,4′-, 4,4′-, and 2,2-biphenyl diisocyanate; polyphenylene polymethylene polyisocyanate (PMDI) (also known as polymeric PMDI); mixtures of MDI and PMDI; mixtures of PMDI and TDI; ethylene diisocyanate; propylene-1,2-diisocyanate; trimethylene diisocyanate; butylenes diisocyanate; bitolylene diisocyanate; tolidine diisocyanate; tetramethylene-1,2-diisocyanate; tetramethylene-1,3-diisocyanate; tetramethylene-1,4-diisocyanate; pentamethylene diisocyanate; 1,6-hexamethylene diisocyanate (HDI); octamethylene diisocyanate; decamethylene diisocyanate; 2,2,4-trimethylhexamethylene diisocyanate; 2,4,4-trimethylhexamethylene diisocyanate; dodecane-1,12-diisocyanate; dicyclohexylmethane diisocyanate; cyclobutane-1,3-diisocyanate; cyclohexane-1,2-diisocyanate; cyclohexane-1,3-diisocyanate; cyclohexane-1,4-diisocyanate; diethylidene diisocyanate; methylcyclohexylene diisocyanate (HTDI); 2,4-methylcyclohexane diisocyanate; 2,6-methylcyclohexane diisocyanate; 4,4′-dicyclohexyl diisocyanate; 2,4′-dicyclohexyl diisocyanate; 1,3,5-cyclohexane triisocyanate; isocyanatomethylcyclohexane isocyanate; 1-isocyanato-3,3,5-trimethyl-5-isocyanatomethylcyclohexane; isocyanatomethylcyclohexane isocyanate; bis(isocyanatomethyl)-cyclohexane diisocyanate; 4,4′-bis(isocyanatomethyl)dicyclohexane; 2,4′-bis(isocyanatomethyl)dicyclohexane; isophorone diisocyanate (IPDI); dimeryl diisocyanate, dodecane-1,12-diisocyanate, 1,10-decamethylene diisocyanate, cyclohexylene-1,2-diisocyanate, 1,10-decamethylene diisocyanate, 1-chlorobenzene-2,4-diisocyanate, furfurylidene diisocyanate, 2,4,4-trimethyl hexamethylene diisocyanate, 2,2,4-trimethyl hexamethylene diisocyanate, dodecamethylene diisocyanate, 1,3-cyclopentane diisocyanate, 1,3-cyclohexane diisocyanate, 1,3-cyclobutane diisocyanate, 1,4-cyclohexane diisocyanate, 4,4′-methylenebis(cyclohexyl isocyanate), 4,4′-methylenebis(phenyl isocyanate), 1-methyl-2,4-cyclohexane diisocyanate, 1-methyl-2,6-cyclohexane diisocyanate, 1,3-bis(isocyanato-methyl)cyclohexane, 1,6-diisocyanato-2,2,4,4-tetra-methylhexane, 1,6-diisocyanato-2,4,4-tetra-trimethylhexane, trans-cyclohexane-1,4-diisocyanate, 3-isocyanato-methyl-3,5,5-trimethylcyclo-hexyl isocyanate, 1-isocyanato-3,3,5-trimethyl-5-isocyanatomethylcyclohexane, cyclohexyl isocyanate, dicyclohexylmethane 4,4′-diisocyanate, 1,4-bis(isocyanatomethyl)cyclohexane, m-phenylene diisocyanate, m-xylylene diisocyanate, m-tetramethylxylylene diisocyanate, p-phenylene diisocyanate, p,p′-biphenyl diisocyanate, 3,3′-dimethyl-4,4′-biphenylene diisocyanate, 3,3′-dimethoxy-4,4′-biphenylene diisocyanate, 3,3′-diphenyl-4,4′-biphenylene diisocyanate, 4,4′-biphenylene diisocyanate, 3,3′-dichloro-4,4′-biphenylene diisocyanate, 1,5-naphthalene diisocyanate, 4-chloro-1,3-phenylene diisocyanate, 1,5-tetrahydronaphthalene diisocyanate, metaxylene diisocyanate, 2,4-toluene diisocyanate, 2,4′-diphenylmethane diisocyanate, 2,4-chlorophenylene diisocyanate, 4,4′-diphenylmethane diisocyanate, p,p′-diphenylmethane diisocyanate, 2,4-tolylene diisocyanate, 2,6-tolylene diisocyanate, 2,2-diphenylpropane-4,4′-diisocyanate, 4,4′-toluidine diisocyanate, dianidine diisocyanate, 4,4′-diphenyl ether diisocyanate, 1,3-xylylene diisocyanate, 1,4-naphthylene diisocyanate, azobenzene-4,4′-diisocyanate, diphenyl sulfone-4,4′-diisocyanate, triphenylmethane 4,4′,4″-triisocyanate, isocyanatoethyl methacrylate, 3-isopropenyl-α,α.-dimethylbenzyl-isocyanate, dichlorohexamethylene diisocyanate, ω,ω′-diisocyanato-1,4-diethylbenzene, polymethylene polyphenylene polyisocyanate, isocyanurate modified compounds, and carbodiimide modified compounds, as well as biuret modified compounds of the above polyisocyanates. These isocyanates may be used either alone or in combination. These combination isocyanates include triisocyanates, such as biuret of hexamethylene diisocyanate and triphenylmethane triisocyanates, and polyisocyanates, such as polymeric diphenylmethane diisocyanate.triisocyanate of HDI; triisocyanate of 2,2,4-trimethyl-1,6-hexane diisocyanate (TMDI); 2,4-hexahydrotoluene diisocyanate; 2,6-hexahydrotoluene diisocyanate; 1,2-, 1,3-, and 1,4-phenylene diisocyanate; aromatic aliphatic isocyanate, such as 1,2-, 1,3-, and 1,4-xylene diisocyanate; meta-tetramethylxylene diisocyanate (m-TMXDI); para-tetramethylxylene diisocyanate (p-TMXDI); trimerized isocyanurate of any polyisocyanate, such as isocyanurate of toluene diisocyanate, trimer of diphenylmethane diisocyanate, trimer of tetramethylxylene diisocyanate, isocyanurate of hexamethylene diisocyanate, and mixtures thereof, dimerized uretdione of any polyisocyanate, such as uretdione of toluene diisocyanate, uretdione of hexamethylene diisocyanate, and mixtures thereof; modified polyisocyanate derived from the above isocyanates and polyisocyanates; and mixtures thereof.

Aromatic isocyanates include, but are not limited to, phenylene diisocyanate, toluene diisocyanate (TDI), xylene diisocyanate, 1,5-naphthalene diisocyanate, chlorophenylene 2,4-diisocyanate, bitoluene diisocyanate, dianisidine diisocyanate, tolidine diisocyanate, alkylated benzene diisocyanates, methylene-interrupted aromatic diisocyanates such as methylenediphenyl diisocyanate, 4,4′-isomer (MDI) including alkylated analogs such as 3,3′-dimethyl-4,4′-diphenylmethane diisocyanate, polymeric methylenediphenyl diisocyanate; and mixtures thereof.

In another aspect, polyisocyanate monomer can be employed. For example, the isocyanate component comprises at least 1 percent by weight, or at least 2 percent by weight, or at least 4 percent by weight of at least one polyisocyanate monomer. Additionally, isocyanate can include oligomeric polyisocyanate, such as, but not limited to, dimers, trimers, and polymeric oligomers, and modified polyisocyanates, such as, but not limited to, carbodiimides and uretone-imines; and mixtures thereof.

The term “prepolymer” means polyisocyanate which is pre-reacted with polyamine or other isocyanate reactive group such as polyol. Suitable polyisocyanates include, but are not limited to, those disclosed herein. Suitable polyamines are numerous and can be selected from a wide variety known in the art. Suitable polyamines include, but are not limited to, primary, secondary and tertiary amines, and mixtures thereof. Further examples include, but are not limited to, those disclosed herein. Likewise, suitable polyols are numerous and can be selected from a wide variety known in the art. Polyols include, but are not limited to, polyether polyols, polyester polyols, polycaprolactone polyols, polycarbonate polyols, polyurethane polyols, poly vinyl alcohols, polymers containing hydroxy functional acrylates, polymers containing hydroxy functional methacrylates, polymers containing allyl alcohols and mixtures thereof.

Amines can be selected from a wide variety of known amines such as primary and secondary amines, and mixtures thereof. In another aspect, the amine includes monoamines, or polyamines having at least two functional groups such as di-, tri-, or higher functional amines; and mixtures thereof. Further, in another aspect, the amine can be aromatic or aliphatic such as cycloaliphatic, or mixtures thereof. Suitable amines include, but are not limited to, aliphatic polyamines such as ethylamine, isomeric propylamines, butylamines, pentylamines, hexylamines, cyclohexylamine, ethylene diamine, 1,2-diaminopropane, 1,4-diaminobutane, 1,3-diaminopentane, 1,6-diaminohexane, 2-methyl-1,5-pentane diamine, 2,5-diamino-2,5-dimethylhexane, 2,2,4- and/or 2,4,4-trimethyl-1,6-diamino-hexane, 1,11-diaminoundecane, 1,12-diaminododecane, 1,3- and/or 1,4-cyclohexane diamine, 1-amino-3,3,5-trimethyl-5-aminomethyl-cyclohexane, 2,4- and/or 2,6-hexahydrotoluoylene diamine, 2,4′- and/or 4,4′-diamino-dicyclohexyl methane and 3,3′-dialkyl-4,4′-diamino-dicyclohexyl methanes (such as 3,3′-dimethyl-4,4′-diamino-dicyclohexyl methane and 3,3′-diethyl-4,4′-diamino-dicyclohexyl methane), 2,4- and/or 2,6-diaminotoluene and 2,4′- and/or 4,4′-diaminodiphenyl methane, or mixtures thereof.

Secondary amines include, but are not limited to, mono- and poly-acrylate and methacrylate modified amines; polyaspartic esters which can include derivatives of compounds such as maleic acid, fumaric acid esters, aliphatic polyamines and the like; and mixtures thereof.

In another aspect, the amine can include an amine-functional resin. Suitable amine-functional resins are selected from a wide variety known in the art and can include those having relatively low viscosity. For example, the amine-functional resin can be an ester of an organic acid, such as, an aspartic ester-based amine-functional reactive resin that is compatible with isocyanate. Yet, in another aspect, the isocyanate can be solvent-free, and/or has a mole ratio of amine-functionality to the ester of no more than 1:1 so that no excess primary amine remains upon reaction.

In another aspect, the amine can include high molecular weight primary amine, such as, but not limited to, polyoxyalkyleneamine. Suitable polyoxyalkyleneamines can contain two or more primary amino groups attached to a backbone derived, for example, from propylene oxide, ethylene oxide, or mixtures thereof.

In another aspect, the amine for use in the present invention can include the reaction product of primary amine with monoepoxide to produce secondary amine and reactive hydroxyl group.

Still, in another aspect, the amine component can be a mixture of primary and secondary amines wherein the primary amine may be present in an amount of from 20 to 80 percent by weight or from 20 to 50 percent by weight, with the balance being secondary amine. In another aspect, the primary amines present in the composition of the outer layer 30 can have a molecular weight greater than 200, and the secondary amines present can include diamine having molecular weight of at least 190, or from 210 to 230.

A primary amine is not required to be present in the amine component. Accordingly, the amine component can be void of primary amine. Also, although not required, the amine component can include at least one secondary amine which is present in an amount of from 20 to 80 percent by weight or 50 to 80 percent by weight.

In another aspect, the amine component can include aliphatic amine to enhance durability. Such amine typically is provided as a liquid having a relatively low viscosity, for example, less than about 100 mPas at 25° C.

A suitable polyurea composition useful in the present invention has the following composition:

| Component | Molecular Weight | Weight Percent |
|---|---|---|
| Polyether diamine | 200-8000 | 50-90 |
| Diamine curing agent | 60-2000 | 5-25 |
| Polyether triamine | 250-10,000 | 2-15 |
| Surfactant | N/A | 0.25-5 |
| Diol chain extender | 62-500 | 2-8 |
| Catalyst | N/A | 0.001-0.100 |
| Colorant | N/A | 0.20-5.0 |
| Additives (moisture | N/A | 1-5% |
| scavenger, UV stabilizer) | | |

Any polyol now known or hereafter developed is suitable for use in the invention. Polyols suitable for use in forming the polyurethane include, but are not limited to, glycols, polyester polyols, polyether polyols, polycarbonate polyols and polydiene polyols such as polybutadiene polyols.

Polyester polyols are prepared by condensation or step-growth polymerization utilizing diacids. Primary diacids for polyester polyols are adipic acid and isomeric phthalic acids. Adipic acid is used for materials requiring added flexibility, whereas phthalic anhydride is used for those requiring rigidity. Some examples of polyester polyols include poly(ethylene adipate) (PEA), poly(diethylene adipate) (PDA), poly(propylene adipate) (PPA), poly(tetramethylene adipate) (PBA), poly(hexamethylene adipate) (PHA), poly(neopentylene adipate) (PNA), polyols composed of 3-methyl-1,5-pentanediol and adipic acid, random copolymer of PEA and PDA, random copolymer of PEA and PPA, random copolymer of PEA and PBA, random copolymer of PHA and PNA, caprolactone polyol obtained by the ring-opening polymerization of ε-caprolactone, and polyol obtained by opening the ring of β-methyl-δ-valerolactone with ethylene glycol can be used either alone or in a combination thereof. Additionally, polyester polyol may be composed of a copolymer of at least one of the following acids and at least one of the following glycols. The acids include terephthalic acid, isophthalic acid, phthalic anhydride, oxalic acid, malonic acid, succinic acid, pentanedioic acid, hexanedioic acid, octanedioic acid, nonanedioic acid, adipic acid, azelaic acid, sebacic acid, dodecanedioic acid, dimer acid (a mixture), ρ-hydroxybenzoate, trimellitic anhydride, ε-caprolactone, and β-methyl-δ-valerolactone. Glycols include ethylene glycol, propylene glycol, butylene glycol, pentylene glycol, 1,4-butanediol, 1,5-pentanediol, 1,6-hexanediol, neopentylene glycol, polyethylene glycol, polytetramethylene glycol, 1,4-cyclohexane dimethanol, pentaerythritol, and 3-methyl-1,5-pentanediol.

Polyether polyols are prepared by the ring-opening addition polymerization of an alkylene oxide (e.g. ethylene oxide and propylene oxide) with an initiator of a polyhydric alcohol (e.g. diethylene glycol), which is an active hydride. Specifically, polypropylene glycol (PPG), polyethylene glycol (PEG) or propylene oxide-ethylene oxide copolymer can be obtained. Polytetramethylene ether glycol (PTMG) is prepared by the ring-opening polymerization of tetrahydrofuran, produced by dehydration of 1,4-butanediol or hydrogenation of furan. Tetrahydrofuran can form a copolymer with alkylene oxide. Specifically, tetrahydrofuran-propylene oxide copolymer or tetrahydrofuran-ethylene oxide copolymer can be formed. The polyether polyol may be used either alone or in a combination.

Polycarbonate polyol is obtained by the condensation of a known polyol (polyhydric alcohol) with phosgene, chloroformic acid ester, dialkyl carbonate or diallyl carbonate. Particularly preferred polycarbonate polyols contain a polyol component using 1,6-hexanediol, 1,4-butanediol, 1,3-butanediol, neopentylglycol or 1,5-pentanediol. Polycarbonate polyols can be used either alone or in a combination with other polyols.

Polydiene polyols include liquid diene polymer containing hydroxyl groups having an average of at least 1.7 functional groups, and can comprise diene polymers or diene copolymers having from about 4 to about 12 carbon atoms, or a copolymer of such diene with addition to polymerizable α-olefin monomer having 2 to 2.2 carbon atoms. Specific examples include butadiene homopolymer, isoprene homopolymer, butadiene-styrene copolymer, butadiene-isoprene copolymer, butadiene-acrylonitrile copolymer, butadiene-2-ethyl hexyl acrylate copolymer, and butadiene-n-octadecyl acrylate copolymer. These liquid diene polymers can be obtained, for example, by heating a conjugated diene monomer in the presence of hydrogen peroxide in a liquid reactant.

Polybutadiene polyol includes liquid diene polymer containing hydroxyl groups having an average of at least 1.7 functional groups, and may be composed of diene polymer or diene copolymer having 4 to 12 carbon atoms, or a copolymer of such diene with addition to polymerizable α-olefin monomer having 2 to 2.2 carbon atoms. Specific examples include butadiene homopolymer, isoprene homopolymer, butadiene-styrene copolymer, butadiene-isoprene copolymer, butadiene-acrylonitrile copolymer, butadiene-2-ethyl hexyl acrylate copolymer, and butadiene-n-octadecyl acrylate copolymer. These liquid diene polymers can be obtained, for example, by heating a conjugated diene monomer in the presence of hydrogen peroxide in a liquid reactant.

As indicated above, the composition comprising the outer layer 30 can include a blend of polyurea and polyurethane. It will be appreciated by those skilled in the art that polyurethane can be formed as a by-product in the production of the polyurea. Moreover, the polyurethane can be formed in-situ and/or it can be added to the reaction mixture during formation of the polyurea. A polyurethane formed in-situ includes, but is not limited to, the reaction product of polyisocyanate and hydroxyl-functional material. Non-limiting examples of suitable polyisocyanates include those described herein. Suitable hydroxyl-functional material includes polyol such as those described herein. Another example of polyurethane formed in-situ includes the reaction product of prepolymer and isocyanate-functional material. Non-limiting examples of these reactants include, but are not limited to, those described herein.

The composition comprising the outer layer 30 can be formulated and deposited onto the three-dimensional layer 20 using various techniques known in the art. For example, conventional spraying techniques can be used. With the spraying technique, the isocyanate and amine are combined such that the ratio of equivalents of isocyanate groups to equivalents of amine groups is greater than 1 and the isocyanate and amine can be applied onto the three-dimensional layer 20 at a volume mixing ratio of 1:1; and the reaction mixture is applied to the three-dimensional layer 20 to form the outer layer 30.

The sprayable composition can be prepared using a conventional two-component mixing device (not shown). For example, isocyanate and amine are added to a high pressure impingement mixing device. The isocyanate is added to the “A-side” and amine is added to the “B-side”. The A- and B-side streams are impinged upon each other and immediately sprayed onto at least a portion of the three-dimensional layer 20. The isocyanate and the amine react to produce a coating of substantially uniform thickness across the “sprayed” area of the three-dimensional layer 20. Since the coating is a flowable liquid as it is deposited onto the three-dimensional layer 20, the coating penetrates and encapsulates at least a portion of, if not substantially all, yarns of the first layer 22 of the three-dimensional layer 20 as illustrated in FIG. 2. In addition, portions of yarns of the third and fourth layers 26 and 28 likewise can be encapsulated by the coating. Upon curing, the outer layer 30 is formed. Moreover, the portion of the cured outer layer 30 encapsulating the yarns of the first, third, and fourth layers 22, 26, and 28 permanently secure the outer layer 30 to the three-dimensional layer 20 to form the three-dimensional composite 10. In this manner, materials which are considered in the art as non-bondable or non-fusable to one another, such as polyurea and/or polyurethane to polyethylene, polypolypropylene and/or polyester, can be permanently secured to one another absent an adhesive.

As understood in the art, the ratio of equivalents of isocyanate groups to amine groups can be selected to control the rate of cure of the composition comprising the outer layer 30. It is believed that cure and adhesion advantages result when applying the coating in a 1:1 volume ratio wherein the ratio of the equivalents of isocyanate groups to amine groups (also known as the reaction index) is greater than one, such as from 1.01 to 1.15:1, or from 1.01 to 1.10:1, or from 1.03 to 1.10:1, or from 1.05 to 1.08:1. The term “1:1 volume ratio” means that the volume ratio varies by up to 20% for each component, or up to 10% or up to 5%.

Another suitable application device known in the industry includes a “static mix tube” applicator (not shown). In this device, the isocyanate and amine are each stored in a separate chamber. As pressure is applied, each of the components is brought into a mixing tube in a 1:1 ratio by volume. Mixing of the components is effected by way of a torturous or cork screw pathway within the tube. The exit end of the tube may have atomization capability useful in spray application of the reaction mixture.

In addition the composition comprising the outer layer 30 can be a polyurea and/or polyurethane foam which is applied by to the three dimensional layer 20 in the manner described above. As known in the art, foams are formed by the addition of a blowing agent to the components forming the polyurea and/or polyurethane. Blowing agents include, but are not limited to, water, methylene chloride, acetone, chlorofluorocarbons (CFCs), hydrofluorocarbons (HFCs), hydrochlorofluorocarbons (HCFCs), hydrocarbons or any combination thereof. Non-limiting examples of HFCs include HFC-245fa, HFC-134a, and HFC-365. Illustrative examples of HCFCs include HCFC-141b, HCFC-22, and HCFC-123. Exemplary hydrocarbons include n-pentane, isopentane, cyclopentane, and the like, or any combination thereof. In the various aspects of the invention, the blowing agent composition comprises at least 75 wt. % water, at least 80 wt. %, at least 85 wt. % water, at least 90 wt. % water, at least 95 wt. % water, or about 100 wt % water.

The amount of blowing agent composition used can vary based on the desired foam stiffness and density. In the foam formulation and method for preparing a rigid polyurethane foam which can be used in the present invention, the water-containing blowing agent composition is present in amounts from about 10 to about 80 parts by weight per hundred weight parts polyol (pphp), from about 12 to about 60 pphp, from about 14 to about 40 pphp, or from about 16 to about 25 pphp.

Urethane catalysts accelerate the reaction to form polyurethanes and polyurethane foams. Urethane catalysts suitable for use herein are known in the art and include, but are not limited to, metal salt catalysts, such as organotins, and amine compounds, such as triethylenediamine (TEDA), N-methylimidazole, 1,2-dimethyl-imidazole, N-methylmorpholine, N-ethylmorpholine, triethylamine, N,N′-dimethyl-piperazine, 1,3,5-tris(dimethylaminopropyl)hexahydrotriazine, 2,4,6-tris(dimethylamino-methyl)phenol, N-methyldicyclohexylamine, pentamethyldipropylene triamine, N-methyl-N′-(2-dimethylamino)-ethyl-piperazine, tributylamine, pentamethyldiethylenetriamine, hexamethyltriethylenetetramine, heptamethyltetraethylenepentamine, dimethylamino-cyclohexylamine, pentamethyldipropylenetriamine, triethanolamine, dimethylethanolamine, bis(dimethylaminoethyl)ether, tris(3-dimethylamino)propylamine, 1,8-diazabicyclo[5.4.0]undecene, bis(N,N-dimethylaminopropyl)-N′-methyl amine and their acid blocked derivatives, or any combination thereof.

An overall thickness of the outer layer 30 can range from 20 to 1000 mils, or from 40 to 150 mils, or from 60 to 100 mils, or from 500 to 750 mils. Typically, the thickness of the outer layer 30 is substantially uniform over the surface of the three-dimensional layer 20 when applied by spraying techniques. However, it is not required for the outer layer 30 to be substantially uniform, and there can be applications in which it is desired for the outer layer 30 to have a thickness at one portion greater than the thickness at another portion, e.g., to level a floor or to create a three-dimensional relief.

Optionally, the composition of the outer layer 30 can include processing additives such as, but not limited to, fillers, flame retardants, fiberglass, stabilizers, moisture scavengers, oxygen scavengers, thickeners, adhesion promoters, catalysts, pigments, other performance or property modifiers which are well known in the art of surface coatings, and mixtures thereof. Such additives can be combined with the isocyanate, the amine, or both. In another aspect, at least one additive is added to the amine prior to reaction with isocyanate.

Flame retardants are known in the art. Suitable flame retardants for use in the present invention include, but are not limited to, flame retardant polymers, halogenated phosphates or halogen-free phosphates, powdered or fumed silica, layered silicates, aluminum hydroxide, brominated fire retardants, tris(2-chloropropyl)phosphate, tris(2,3-dibromopropyl)phosphate, tris(1,3-dichloropropyl)phosphate, diammonium phosphate, various halogenated aromatic compounds, antimony oxide, alumina trihydrate, polyvinyl chloride and the like, and mixtures thereof.

In another aspect, the composition comprising the outer layer 30 can include silica, provided that application and coating performance properties are not adversely impacted. The silica can be surface-treated/surface-modified silica, untreated/unmodified silica, and mixtures thereof. Examples of suitable silica include, but are not limited to, precipitated, fumed, colloidal, and mixtures thereof. Silica can be present in an amount such that it constitutes at least 0.5 percent by weight, or at least 1 percent by weight, or at least 1.5 percent by weight of the outer layer 30. In another aspect, the silica can be present in an amount up to 6 percent by weight, or up to 5 percent by weight, or up to 4 percent by weight of the composition comprising the outer layer 30. The amount of silica in the two-component coating composition can be any value or range between any values recited above, provided that the adhesion properties and application viscosity of the coating composition are not adversely affected.

In another aspect, the composition of the outer layer 30 can include, but not required, an adhesion promoter which may enhance adhesion of the composition comprising the outer layer 30 to the three-dimensional layer 20. The adhesion promoter can be applied to the first layer 22 of the three-dimensional layer 20, or it can be added to the isocyanate and/or amine of the composition forming the outer layer 30. Adhesion promoters employable in the present invention include, but are not limited to, amine-functional materials such as 1,3,4,6,7,8-hexahydro-2H-pyrimido-(1,2-A)-pyrimidine, hydroxyethyl piperazine, N-aminoethyl piperizine, dimethylamine ethylether, tetramethyliminopropoylamine, blocked amines such as an adduct of IPDI and dimethylamine, tertiary amines, such as 1,5-diazabicyclo[4.3.0]non-5-ene, 1,8-diazabicyclo[5.4.0]undec-7-ene, 1,4-diazabicyclo[2.2.2]octane, 1,5,7-triazabicyclo[4.4.0]dec-5-ene, and 7-methyl-1,5,7-triazabicyclo[4.4.0]dec-5-ene, amino silanes such as γ-aminopropyltriethoxysilane, melamine or amino melamine resin, metal complexes including metal chelate complexes such as an aluminum chelate complex or tin-containing compositions such as stannous octoate and organotin compounds such as dibutyltin dilaurate and dibutyltin diacetate, urethane acrylate compositions, salts such as chlorine phosphate, butadiene resins such as an epoxidized, hydroxyl terminated polybutadiene resin, polyester polyols, and urethane acrylate compositions such as an aromatic urethane acrylate oligomers, and mixtures thereof.

The composition comprising the outer layer 30 can include one or more pigments. Pigments include color or effect-enhancing pigments. Referring to FIG. 5, the pigment can be present in the composition of the outer layer 30 and/or a coating layer 40 disposed on the outer layer 30. The coating layer 40 is particularly useful in creating decorative effects, such as grout lines, wood grains, or mosaics, etc. Suitable pigments can include, but are not limited to, metallic pigments, organic color pigments, inorganic color pigments, or mixtures thereof. Examples of such pigments include, but are not limited to, metallic pigments such as aluminum flake, copper bronze flake and micaceous pigments such as metal oxide coated mica; inorganic pigments such as titanium dioxide, iron oxide, chromium oxide, lead chromate, and carbon black; and organic pigments such as phthalocyanine blue and phthalocyanine green; and mixtures thereof.

Pigment can be present in the composition comprising the outer layer 30 in an amount of from 1 to 80 percent by weight based on the total weight of coating solids. In another non-limiting embodiment, the metallic pigment can be present in an amount of from 0.5 to 25 percent by weight based on the total weight of coating solids.

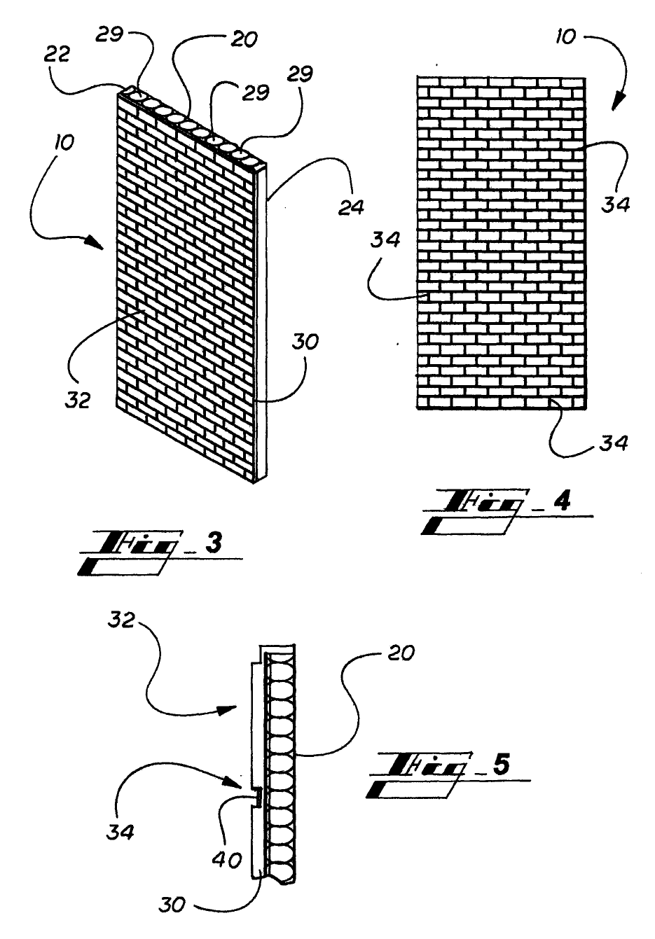

Referring to FIGS. 3-5, the monolithic three-dimensional composite 10 can comprise the outer layer 30 having a three-dimensional relief 32. FIGS. 3-5 illustrate the monolithic three-dimensional composite 10 with the outer layer 30 having a three-dimensional relief 32 in a pattern of a brick replication with grout lines 34. The brick pattern is only exemplary and should not be considered as limiting. Such three-dimensional relief 32 can be of any desired three-dimensional pattern such as tile, stone, parquet, etc.

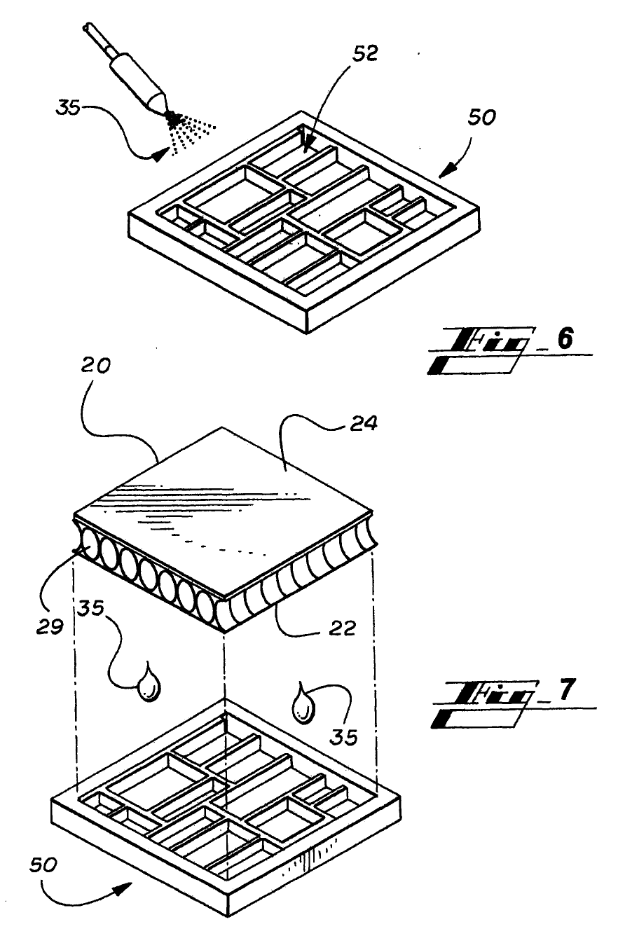

Referring to FIGS. 6 and 7, in forming the composite 10 having the three-dimensional relief 32, a patterned mold 50 is employed. In the following discussion, the term negative pattern is employed in reference to a patterned mold. As known in the casting art, a negative pattern is made of a desired three-dimensional shape and/or pattern to be replicated, and a patterned mold is formed containing the negative pattern. Once the negative pattern 52 of the patterned mold 50 is filled with liquid polymer and allowed to cure, the solid outer layer 20 reproduces the desired three-dimensional shape and/or pattern, i.e, the three-dimensional relief.
In one aspect, a process to make a monolithic three-dimensional composite 10 having a three-dimensional relief 32 comprises:
1) placing an uncured polymer composition 35, such as polyurea, polyurethane, or a blend thereof, into a patterned mold 50 having a negative pattern of a desired three-dimensional relief by any conventional means;
2) placing a three-dimensional layer 20 in contact with the liquid polymer composition 35 in the mold 50 such that at least a portion of the first layer 22 is embedded within or encapsulated by the polymer composition 35; and
3) curing the polymer composition 35 to form the monolithic three-dimensional composite 10 having the three-dimensional relief 32 on the outer layer 30.

The compositions of the three-dimensional layer 20 and the outer layer 30 are discussed in detail above. Prior to placing the uncured polymer composition into the mold 50, portions or all of the surface of the negative pattern 52 of the mold 50 can be coated with a colored composition that compatibly bonds to the composition of the cured outer layer 30 to form decorative colored layers 40, typically in register with the pattern of the three-dimensional relief 32.

After curing, the outer layer 32 comprises a durable decorative layer of varying thickness substantially corresponding to the desired pattern. Moreover, composite 10 of the present invention has the benefit of being removed from the mold as a finished product. That is, no further assembly of the composite 10 is necessary prior to end use/installation. Yet, the composite 10 can be further decorated, if desired, by painting or other treatment known in the art to enhance the decorative effect and/or provide a natural appearance to the three-dimensional relief 32.

Referring to FIGS. 8 and 9, as discussed above, the three-dimensional relief 32 can be formed by mechanical embossing in addition to or exclusive of the molding process described above. The outer surface 31 of the outer layer 30 can have surface texture that optionally is in register with the pattern of the print layer 36. Such texture can be created by mechanical embossing or other embossing techniques known to those skilled in the art. More than one device can be employed to mechanically emboss different textures onto the outer layer 30.

For example, when it is desired for the three-dimensional composite 10 to simulate a wood design, the embossed texture can resemble wood grains, wood knots, and the like. For a ceramic print design, the embossed texture can simulate the texture of a ceramic tile surface. Similarly, for a stone print design, the embossed texture can simulate the texture of a stone surface. In addition, the embossed texture can simulate grout lines or seams in addition to any desired three-dimensional relief 32. Typically, the depth of the embossing on the upper surface can be from about 0.5 mil to about 15 mils. Yet, this range of embossing depth is not meant to be limiting. Rather, the embossing depth can be more or less than this range, and the maximum embossing depth is limited only by the thickness of the outer layer 30.

The printed pattern on the outer surface 31 of the outer layer 30 can have any pattern, such as, but not limited to, simulated natural surfaces, such as natural wood, stone, tile, marble, granite, brick appearance, or the like. Any ink composition can be used which is compatible with the polymer composition of the outer layer 30, such as those that contain an acrylic resin, water, alcohol, and one or more pigments. A printed design of the print layer 36 can be formed by screen printing, in register printing using multiple station rotogravure printing, or any printing technique known in the art.

Surface texture effects, as illustrated in FIG. 9, can be obtained by creating relatively deep emboss depths as compared with the shallow graining or dusting techniques employed to obtain a matted or differential gloss effect. As a result, a substantially realistic imitation on the outer surface 30 can be obtained to simulate the surface texture of a variety of masonry materials such as ceramic tile, stone, brick, sandstone, cork, wood and combinations thereof. In addition, it is possible to mechanically emboss a realistic imitation of the surface texture of the grout or mortar in the joints or grout lines 34 between such materials.

The embossing depth can vary throughout the entire outer surface 31 of the outer layer 30 depending upon the features that are being simulated. Further, although not required, embossing can be in register with the pattern of the print layer 36. As indicated above, the print layer 36 is optional. Accordingly, the outer layer 30 can be embossed whether or not the print layer 36 is present. With respect to the outer surface 31 and the embossed texture, the texture can be present on the print layer 36, and/or on the wear layer 38. The wear layer 38 can be one or more layers, and can comprise more than one layer, such as a layer known as a wear layer and a protective layer (e.g., top coat layer or wear top coat layer(s)), or other layers, such as a strengthening layer. Any one or more of these layers can be embossed to have texture. In addition, it is possible to conduct multiple embossing operations to emboss the outer layer 30, the print layer 36, and the wear layer 38, or any combination thereof.

Referring to FIG. 10, a process for embossing the three-dimensional composite 10 is illustrated. Initially, the three-dimensional composite 10 is formed by either of the processes described above. The print layer 36 is optionally present on the outer surface 31 of the outer layer 30. If a wear layer is to be employed and embossed, the wear layer is disposed onto the outer surface 31 of the outer layer 30 by a coating means 60. On the portions of the outer surface 31 in which the print layer 36 is present, the print layer 36 receives the wear layer 38. As illustrated, coating means 60 comprises a spray nozzle 61 and a doctoring blade 62. Alternatively, a reverse-roll coater (not shown) can be employed. The polymeric composition comprising the wear layer 38 is sprayed onto a coating drum 63, and the thickness of the wear layer 38 is determined by the space between the doctoring blade 62 and the surface of the coating drum 63. As the coating drum 63 is rotated, the wear layer 38 is deposited onto the outer surface 31 and/or print layer 36. Thereafter, the wear layer 38 is allowed to cure and adhere to the outer surface 31 and/or print layer 36. Depending upon the polymeric composition comprising the wear layer 38, a heat source 70, e.g., radiant oven, gas-fired oven, etc., may be employed to assist in curing the wear layer 38. During and/or after curing, the wear layer 38 is permitted to obtain ambient temperature. Thereafter, the surface of the wear layer 38 is subjected to a sufficient temperature to soften the cured wear layer surface by reheating with heat source 72, e.g., an infrared radiant heat oven. This step softens the surface of the wear layer 38 to permit mechanical embossing. Next, embossing drum 80, which has a negative embossing pattern disposed thereon, embosses the wear layer 38 to have any surface texture. During mechanical embossing, the outer layer 30 may or may not be mechanically embossed. If composite 10 is void of a wear layer, the outer surface 31 of the outer layer 30 and the print layer 36, if present, are heated by heat source 72 and mechanically embossed by the embossing drum 80 to form an embossed composite. If desired, the embossed composite can have a wear layer 38 applied as described above and thereafter the wear layer 38 embossed. It will be appreciated by one of ordinary skill in the art that multiple combinations of embossing can be applied to the composite 10 to achieve the desired embossed surface appearance.

Impact tests were conducted in accordance with ASTM Standards E1886 and E1196. A test unit consisting of a 21 inch×21 panel of the three-dimensional composite 10 was tested. The three-dimensional layer 20 was a plain 4-layer tubular weave having a thickness of about 625 mils. In the warp direction, non-shrink yarn was 20 mil round polypropylene and the shrink yarn was a 315 denier low density polyethylene round monofilament. Fill yarn was 565 denier round monofilament polypropylene. The three-dimensional layer 20 was spray coated with polyurea to form an outer layer 30 having a thickness between 30-40 mils.

The polyurea was formed by mixing a 4,4′-MDI/polypropylene glycol (2000 molecular weight) prepolymer, NCO 10-25%, and an amine mixture of polyether diamine (JEFFAMINE® D2000), secondary diamine (POLYLINK 4200), and polyether triamine (JEFFAMINE® T5000), in a high pressure, impingement mix sprayer (Graco Reactor H20/35) at a volume ratio of 1:1 and sprayed onto the three-dimensional layer 20. The composition was allowed to cure to form the outer layer 30. The amine mixture had the following composition:

| | | | Weight Percent |
|---|---|---|---|
| | Molecular | | of Amine |
| Component | Weight | Name | Mixture |
| Polyether diamine | 2000 | D2000 | 51.2 |
| Diamine curing agent | 178 | DETDA*¹ | 25.0 |
| Polyether triamine | 5000 | T5000 | 8.3 |
| Secondary diamines | 310 | PL4200*² | 12.7 |
| Colorant | N/A | Repi Orange | 0.75 |
| Moisture scavenger | N/A | PolyGrab AS 1100 | 0.55 |
| UV stabilizer | N/A | PolyStab 100 | 1.5 |

*¹diethyltoluenediamine, CAS#: 68479-98-1;
*²Polylink4200: CAS# 5285-60-9

The test unit was strapped to impact stands and impacted at the geometric center with a missile 92 inches in length, 4 inches wide, 2 inches in height, and weighing about 9.25 pounds. After each impact at 102 ft/sec., the unit was inspected for damage to the outer layer 30. No tears, cuts, or breakage to the outer layer 30 were discovered. From the result, it can be concluded that the unit demonstrated enhanced impact resistance.

In accordance with the present invention, the monolithic three-dimensional composite 10 comprises the three-dimensional layer 20 of the single-weave, three-dimensional fabric described above, the outer layer 30 described above disposed within a portion of and extending outwardly from the three-dimensional layer 20, and the composite 10 having an impact resistance of at least 90 feet/second as measured in accordance with ASTM Standards E1886 and E1996. In another aspect the composite 10 has an impact resistance of at least 95, at least 100, at least 105, at least 110, at least 115, at least 120, at least 125, at least 130, at least 135, at least 140, at least 145, or at least 150 feet/second as measured in accordance with ASTM Standards E1886 and E1996.

As discussed above, because the composite 10 has the benefit of comprising the light-weight three-dimensional layer 20, it is a light-weight product that provides durability, strength, impact resistance, and load-bearing capability. Since the composite 10 is light-weight, it is also easy to handle and install. Yet, because the three-dimensional layer 20 is a woven fabric, air-flow and moisture dissipation is provided while the outer layer 30 acts as a vapor barrier.

The process of the present invention improves efficiency while improving quality with a concomitant reduction of costs and time in production, handling, and assembly. The process can utilize mold designs that enable fastening or joining of individual product units.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

Other than in any operating examples, or where otherwise indicated, all numbers expressing quantities of ingredients, reaction conditions and so forth used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Therefore, the foregoing is considered as illustrative only of the principles of the invention. Moreover, the monolithic three-dimensional composite 10 can be employed in many applications beyond flooring and panel constructions, and such uses are not meant to be limiting. Further, various modifications may be made of the invention without departing from the scope thereof and it is desired, therefore, that only such limitations shall be placed thereon as are imposed by the prior art and which are set forth in the appended claims.

What is claimed is:

1. A monolithic three-dimensional composite comprising:
a three-dimensional layer comprising a single-weave, three-dimensional fabric, and
an outer layer disposed within a portion of and extending outwardly from the three-dimensional fabric, the outer layer being a polyurea, a polyurethane, a blend of a polyurea and a polyurethane, a polyurea foam, a polyurethane foam, or a foam of blend of a polyurea and a polyurethane.

2. The composite as claimed in claim 1, wherein the outer layer is mechanically embossed.

3. The composite as claimed in claim 1, wherein the outer layer has an outer surface and further comprising a print layer disposed on the outer surface.

4. The composite as claimed in claim 3, wherein the outer layer is mechanically embossed.

5. The composite as claimed in claim 4, wherein the outer layer is mechanically embossed in register with at least a portion of the print layer.

6. The composite as claimed in claim 1, wherein the three-dimensional fabric comprises at least one shrink yarn and at least one non-shrink yarn.

7. The composite as claimed in claim 1, wherein the outer layer has a three-dimensional relief.

8. The composite as claimed in claim 1, wherein the three-dimensional relief is mechanically embossed.

9. The composite as claimed in claim 1, further comprising a wear layer disposed on the outer layer.

10. The composite as claimed in claim 3, further comprising a wear layer disposed on the print layer.

11. A monolithic three-dimensional composite comprising:
a three-dimensional layer comprising a plain 4-layer tubular weave fabric, and
an outer layer disposed within a portion of and extending outwardly from the three-dimensional fabric, the outer layer being a polyurea, a polyurethane, a blend of a polyurea and a polyurethane, a polyurea foam, a polyurethane foam, or a foam of blend of a polyurea and a polyurethane.

12. The composite as claimed in claim 11, wherein the outer layer is mechanically embossed.

13. The composite as claimed in claim 11, wherein the outer layer has an outer surface and further comprising a print layer disposed on the outer surface.

14. The composite as claimed in claim 13, wherein the outer layer is mechanically embossed.

15. The composite as claimed in claim 14, wherein the outer layer is mechanically embossed in register with at least a portion of the print layer.

16. The composite as claimed in claim 11, wherein the fabric comprises at least one shrink yarn and at least one non-shrink yarn.

17. The composite as claimed in claim 11, wherein the outer layer has a three-dimensional relief.

18. The composite as claimed in claim 11, wherein the three-dimensional relief is mechanically embossed.

19. The composite as claimed in claim 11, further comprising a wear layer disposed on the outer layer.

20. The composite as claimed in claim 13, further comprising a wear layer disposed on the print layer.

21. The composite as claimed in claim 11, wherein the fabric comprises polypropylene yarn and polyethylene yarn.

22. The composite as claimed in claim 11, wherein the fabric comprises yarns having a size between about 500 denier to about 5,000 denier.

23. The composite as claimed in claim 11, wherein the fabric comprises non-shrink yarns having a size in a range between about 8 mils to about 30 mils.

24. The composite as claimed in claim 11, wherein the fabric comprises shrink yarns having a size in a range between about 150 denier to about 1,800 denier.

25. The composite as claimed in claim 11, wherein the fabric comprises shrink yarns having a size in a range between about 200 to about 1,800 denier.

26. The composite as claimed in claim 11, wherein the fabric comprises 20 mil, round polypropylene yarn and 315 denier, round low density polyethylene monofilament.

27. The composite as claimed in claim 11, wherein the fabric comprises a thickness of about 500 mils.

28. The composite as claimed in claim 11, wherein the fabric comprises a thickness between about 150 mils to about 1,200 mils.

29. The composite as claimed in claim 11, wherein the fabric comprises a weight of about 18 ounces/yard².

30. The composite as claimed in claim 11, wherein the fabric comprises a weight of about 16 ounces/yard²±5 ounces/yard².

31. The composite as claimed in claim 11, wherein the fabric has no more than about a 10% compression at a load of at least 20 pounds/inch².

32. The composite as claimed in claim 11, wherein the fabric has no more than about a 10% compression at a load of at least 25 pounds/inch².

33. The composite as claimed in claim 11, wherein the fabric has no more than about a 10% compression at a load of at least 32 pounds/inch².

34. The composite as claimed in claim 11, wherein the fabric has no more than about a 25% compression at a load of at least 38 pounds/inch².

35. The composite as claimed in claim 11, wherein the fabric has no more than about a 50% compression at a load of at least 45 pounds/inch².

36. The composite as claimed in claim 11, wherein the fabric has no more than about a 10% compression at a load of at least 32 pounds/inch², no more than about a 25% compression at a load of at least 38 pounds/inch², and no more than about a 50% compression at a load of at least 45 pounds/inch².

37. A method of making a monolithic three-dimensional composite having a three-dimensional relief comprising:
1) placing an uncured, liquid polymer composition of a polyurea, a polyurethane, a blend of a polyurea and a polyurethane, a foamable polyurea, a foamable polyurethane, or a foamable of blend of a polyurea and a polyurethane into a patterned mold having a negative pattern of a desired three-dimensional relief;
2) placing a three-dimensional layer comprising a woven fabric having a plain 4-layer tubular weave in contact with the liquid polymer composition such that at least a portion of the fabric is embedded within or encapsulated by the polymer composition; and
3) curing the polymer composition to form the monolithic three-dimensional composite having the three-dimensional relief on the outer layer.

38. A monolithic three-dimensional composite comprising:
a three-dimensional layer comprising a single-weave, three-dimensional fabric, and
an outer layer disposed within a portion of and extending outwardly from the three-dimensional fabric, the outer layer being a polyurea, a polyurethane, a blend of a polyurea and a polyurethane, a polyurea foam, a polyurethane foam, or a foam of blend of a polyurea and a polyurethane,
the composite having an impact resistance of at least 90 feet/second as measured in accordance with ASTM Standards E1886 and E1996.

39. The composite as claimed in claim 38, wherein the composite has an impact resistance of at least 100 feet/second as measured in accordance with ASTM Standards E1886 and E1996.

40. The composite as claimed in claim 38, wherein the composite has an impact resistance of at least 110 feet/second as measured in accordance with ASTM Standards E1886 and E1996.

41. The composite as claimed in claim 38, wherein the composite has an impact resistance of at least 115 feet/second as measured in accordance with ASTM Standards E1886 and E1996.

42. The composite as claimed in claim 38, wherein the composite has an impact resistance of at least 120 feet/second as measured in accordance with ASTM Standards E1886 and E1996.

43. The composite as claimed in claim 38, wherein the composite has an impact resistance of at least 125 feet/second as measured in accordance with ASTM Standards E1886 and E1996.
